(19) United States
(12) Patent Application Publication
(10) Pub. No.: US 2006/0085434 A1
(43) Pub. Date: Apr. 20, 2006

(54) System and method for deriving and visualizing business intelligence data

(75) Inventors: Teresa Mah, Bellevue, WA (US); Ying Li, Bellevue, WA (US); Benyu Zhang, Beijing (CN)

Correspondence Address: SHOOK, HARDY & BACON L.L.P.;(c/o MICROSOFT CORPORTATION), 2555 GRAND BOULEVARD, KANSAS CITY, MO, 64108-2613, US

(73) Assignee: Microsoft Corporation, Redmond, WA (US)

(21) Appl. No.: 10/953,183

(22) Filed: Sep. 30, 2004

(51) Int. Cl. G06F 7/00

(52) U.S. Cl. 707/100

(57) ABSTRACT

A system and method are provided for deriving business intelligence (BI) data and exploring the derived data. The system may include a business intelligence engine and a business intelligence visualizer. The BI engine may be responsible for deriving or discovering fact summary data. The fact summary data may include aggregated or trend data in addition to the dimension or measure data. The BI engine may include components for determining fact summary data such as “What's Hot” and “What's Not Hot”. The components of the BI engine may include an algorithm for automatically generating “hotness scores” for members of dimensions or combinations of dimensions. The BI visualizer provides a chart node tree display for user exploration.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to a system and method for deriving and visualizing business intelligence data. More particularly, the system and method of the invention relate to providing business intelligence data with explanatory power.

### BACKGROUND OF THE INVENTION

Businesses today often use web sites to disseminate information and have an interest in collecting information about user actions on the web sites in order to determine which content is most interesting or least interesting to individual users as well as to various categories of users. Thus, tracking mechanisms have been developed to gather information regarding user-browsing activities such as click-through rates or keywords searched or other user activities. Once the information is gathered, it may be stored in a database for subsequent analysis. Other information aside from tracked user data can also be stored in the database for subsequent analysis and can include revenue generated through purchases, demographic characteristics of purchasers, and other data drawn from a variety of possible sources.

Online Analytical processing (OLAP) systems have been developed to enable analysis of information from a database. Typically, an OLAP server is implemented that understands data organization within the database and includes functions for analyzing the data.

Business intelligence (BI) systems have been developed to interact with OLAP servers and provide detailed information in a manner that is useful to businesses. These BI systems come in many varieties, some of which include data mining applications, customer relationship management (CRM) enterprise systems, link analysis programs, and fraud detection identifiers. Each of these BI systems answers different types of questions. However, none of these systems has been able to provide the broad range of information needed by executives and business analysts in a graphic and explanatory fashion. Accordingly, a system is needed for calculating a variety and wealth of business intelligence fact summary data based on OLAP dimension and measurement information. Furthermore, a system is needed that includes a visual user interface designed for exploiting this type of data for ease of exploration and analysis.

### BRIEF SUMMARY OF THE INVENTION

Embodiments of the present invention include a business intelligence visualization system for presenting business intelligence data to a user. The visualization system includes a node tree structure generation mechanism for generating a node as a portion of a tree for displaying data and a drilling component for allowing user selection of at least one additional node for generation by the node tree structure generation mechanism.

In a further aspect of the invention, a business intelligence system is provided for deriving and displaying business intelligence data. The business intelligence system includes a business intelligence engine for analyzing information retrieved from a database. The business intelligence engine includes a change calculation mechanism for calculating a measure of change between a member value during a previous time period (or function of member values during previous time periods) and a member value in a current time period. The business intelligence engine additionally includes a relevance calculation mechanism for calculating a member value percentage within a category and a hot value calculation module for calculating whether a member has a hot status based upon the relevance calculation and the change calculation for that member. The system additionally includes a business intelligence visualizer for creating a graphic display for conveying at least one of change, relevance, and hot status.

In an additional aspect, a method is provided for deriving business intelligence data with information extracted from a database. The method includes determining a measure of change between a member value during a previous time period (or function of member values during previous time periods) and a member value in a current time period, and assessing relevance by taking the actual member value or calculating a member value percentage within a category. The method additionally includes ranking hot items for display based on a combination of relevance and change.

In yet a further aspect, a method is provided for organizing and displaying business intelligence data. The method includes implementing a node tree structure generation mechanism for generating a node as a portion of a tree for displaying data and providing a drilling component for allowing user selection of at least one additional node for generation by the node tree structure generation mechanism.

### BRIEF DESCRIPTION OF THE DRAWINGS

The present invention is described in detail below with reference to the attached drawings figures, wherein:

FIG. 1 is a block diagram illustrating an overview of a system in accordance with an embodiment of the invention;

FIG. 2 is block diagram illustrating a computerized environment in which embodiments of the invention may be implemented;

FIGS. 3A and 3B are block diagrams illustrating a business intelligence system in accordance with embodiments of the invention;

FIG. 4 illustrates a summary mode of a business intelligence visualizer in accordance with embodiments of the invention;

FIG. 5 illustrates an exploratory mode of a business intelligence visualizer in accordance with embodiments of the invention;

FIG. 6 illustrates an additional view of exploratory mode illustrating a tree structure in accordance with embodiments of the invention;

FIG. 7 illustrates an additional view of exploratory mode in accordance with embodiments of the invention; and

FIG. 8 illustrates an exploratory mode view including a chart node tree in accordance with embodiments of the invention.

### DETAILED DESCRIPTION OF THE INVENTION

I. System Overview

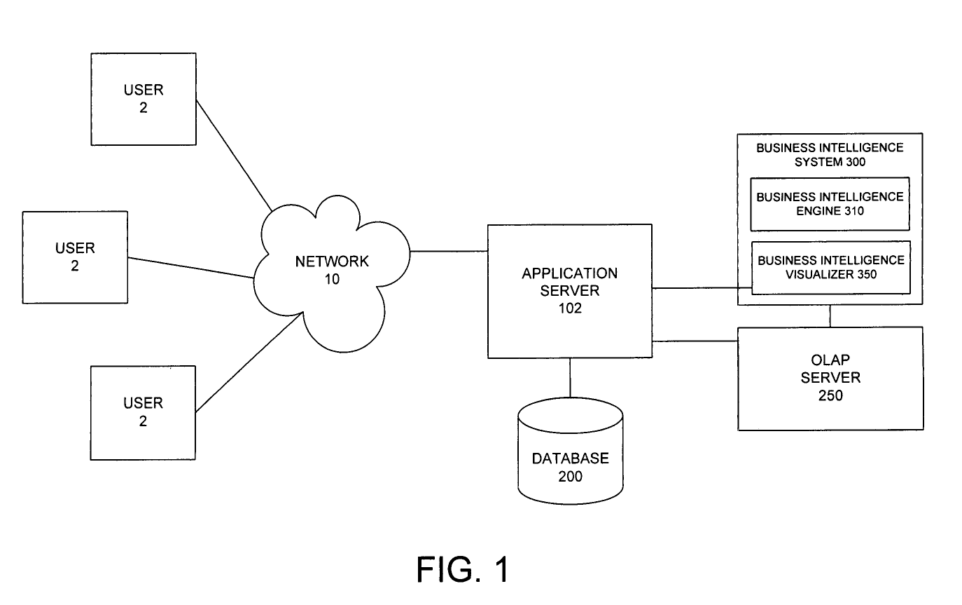

As illustrated in FIG. 1, multiple users 2 may be connected over a network 10 with an application server 102. The application server 102 may include applications for interacting with the users 2. The application server 102 may be connected with a database 200. The database 200 may store data collected through the application server 102. An OLAP server 250 may be connected with the application server 102 in order to extract data from the database 200. A business intelligence (BI) system 300 may be connected with the application server 102 and the OLAP server 250 in order to extract data from the OLAP server and derive additional data. The users 2 may include customers or advertisers utilizing the applications within the application server 102. The users 2 may additionally include executives, analysts, advertisers or other parties interested in data derived and displayed by the BI system 300. The users 2 may also be connected directly with the BI system 300.

The BI system 300 accepts OLAP dimension and measure data, but also may display an extra level of information called “Fact Summaries” in addition to dimension and measure data. In exemplary embodiments, measures might include revenue, average bid amount, click-through rate, and impression count. Dimensions may include for example, advertiser, advertiser country, advertiser industry, keyword, category of keywords, advertisement, advertisement type, and advertisement size. Fact summaries may provide measures for dimensions in increasing or decreasing order.

The BI engine 310 of the BI system 300 may be responsible for deriving or discovering fact summary data. The fact summary data may include aggregated or trend data in addition to the dimension or measure data. The BI engine 310 may include components for determining fact summary data such as “What's Hot” and “What's Not Hot”. The components of the BI engine 310 may include an algorithm for automatically generating “hotness scores” for members of dimensions or combinations of dimensions. Further descriptions of exemplary algorithms will be provided below.

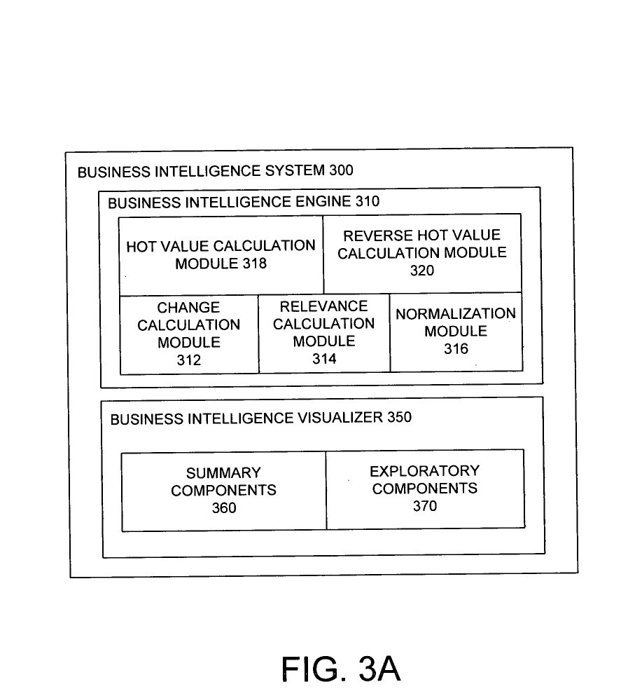

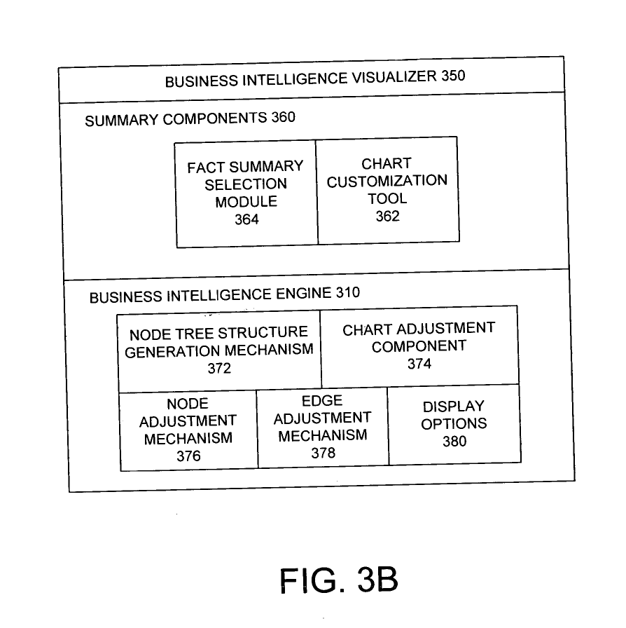

The BI visualizer 350 of the BI system 300 may include components for showing the fact summaries created by the BI engine 310 in different types of views. For instance, the BI visualizer 350 may show “hot facts” in many different forms, such as an ordered list of the top five hot items or the bottom five hot items. The BI visualizer 350 may operate in summary and exploratory modes. Fact summaries are shown in summary mode in the visualizer 350. The exploratory mode of the visualizer 350 includes a component for generating a chart tree, where each node in the tree is represented as a chart. The modes of the visualizer 350 will be further described below with reference to FIG. 3.

II. Exemplary Operating Environment

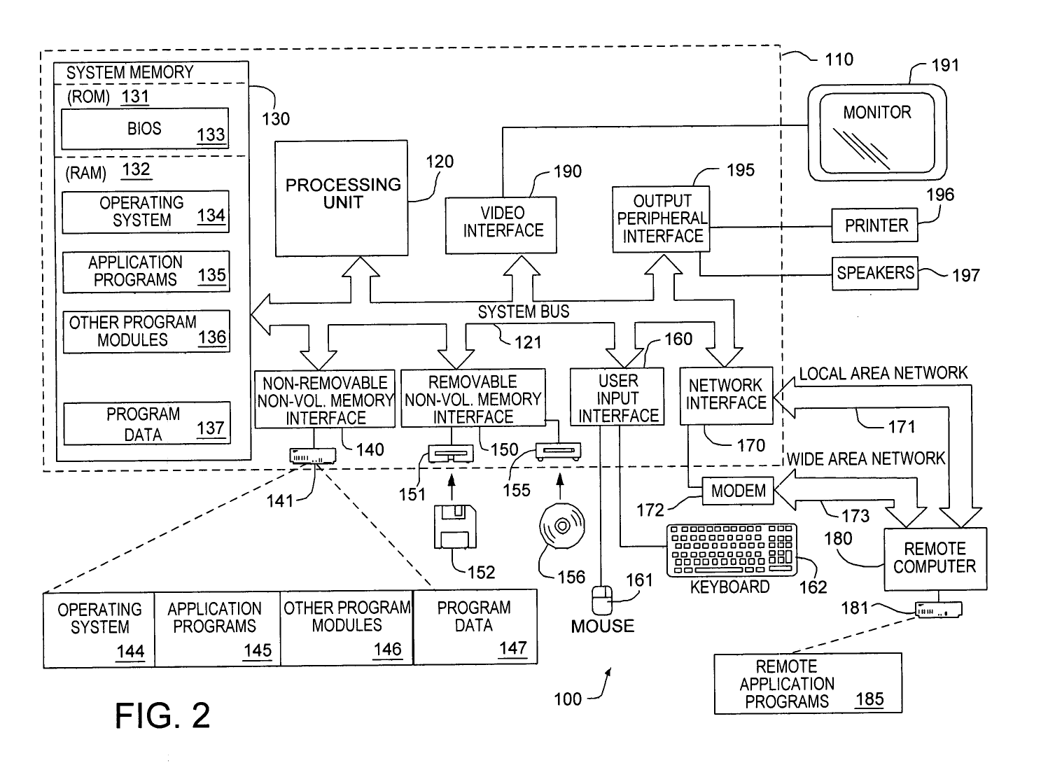

FIG. 2 illustrates an example of a suitable computing system environment 100 on which the BI system 300 may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. System and Method of the Invention

As set forth above, FIG. 1 illustrates a BI System 300 connected with an OLAP server 250 and application server 102 associated with a database 200. The BI Engine 300 may accept OLAP dimension and measure data, but also may display an extra level of information called “Fact Summaries” in addition to dimension and measure data. In exemplary embodiments, measures might include revenue, average bid amount, click-through rate, and impression count. Dimensions may include advertiser, advertiser country, advertiser industry, keyword, category of keyword, advertisement type, advertisement size, and other available dimensions. Fact summaries may provide measures for dimensions in a structured manner, such as in increasing or decreasing order.

As set forth above, the BI system 300 may include a BI engine 310 and a BI visualizer 350. As illustrated in FIG. 3A, the BI engine 310 may include a hot value calculation module 318, a reverse hot value calculation module 320, a change calculation module 312, a relevance calculation module 314, and a normalization module 316. The BI visualizer 350 may include summary components 360 and exploratory components 370.

The BI engine 310 may be responsible for deriving or discovering fact summary data. The fact summary data may include aggregated or trend data in addition to the dimension or measure data. In particular, the BI engine 310 may include components 318 and 320 for determining fact summary data such as “What's Hot” and “What's Not Hot”.

The question of “What's Hot” is actually a two-part question. To determine what's hot, the BI engine 310 determines (1) what's relevant and (2) what's new or what's changed. As illustrated in FIG. 3, the change calculation module 312 may calculate newness or “what's new” and the relevance calculation module 314 may calculate relevance. For example, an advertiser might have a ten-fold increase in click-through rate in a current month compared to a previous month but if the advertiser's original click-through rate was only 0.0002% this does not mean that the advertiser is “hot”. However, if the advertiser's original click-through rate was 0.1% and has increased to 1%, this is a more “relevant” finding than the previous one. In the first instance, the change calculation module 312 would calculate a high number, but the relevance calculation module 314 would calculate a low relevance. In the second instance, the relevance calculation would be higher.

In order to calculate relevance, the relevance calculation module 314 calculates a relevance score R. The relevance score R may be taken as the measure itself or as a percentage of the measure. For example, if the relevance calculation module 314 calculates relevance pertaining to revenue, the relevance will be the percentage of revenue that the member in a dimension represents or the actual revenue itself.

This technique provides a ranking of member relevance. Within the advertiser dimension, different advertisers each represent a portion of the overall revenue within a given timeframe. For instance, Qwest might represent 10% of overall revenue, Best Buy may represent 8%, AT&T may represent 7%, Ameritrade 6%, and Bank of America 4%. In this example, Qwest's relevance score would be 0.1, Best Buy's relevance is 0.08, AT&T has a relevance of 0.07, Ameritrade has a relevance of 0.06, and Bank of America has a relevance of 0.04.

However, calculation of relevance alone does not determine “what's hot.” As an example, the United States may consistently represent 50% of worldwide advertising revenue. Although this statistic has a high relevance, the United States is not “hot” unless its share of the percentage has increased. Accordingly, the change calculation module 312 supplements the relevance calculation module 314 to contribute to the determination of “what's hot”.

The change calculation module 312 calculates a newness score N that measures the quality of a finding. The newness score N is measured by taking a function of the current time period's value for a member (i.e. % of revenue or click-through rate) and the previous time period's value (or combination of previous time periods' values). The time period may be an hour, a day, a month or any selected time period. Thus, the change calculation module 312 compares a value for a current month with a previous month's value or a value for a current day with a previous day's value. In embodiments of the invention, a system user can set the time period. For example, if Qwest's relevance score in the current month is 0.10 and the relevance score in the previous month was 0.05 then Qwest's newness score will be 2.0 if the newness function is R_{current}/Rₚᵣₑᵥᵢₒᵤₛ. Newness N may be calculated by implementing any of the following methods:
R_{current}/Rₚᵣₑᵥᵢₒᵤₛ (1)
(R_{current}−Rₚᵣₑᵥᵢₒᵤₛ)/Rₚᵣₑᵥᵢₒᵤₛ (2)
(R_{current}−Rₚᵣₑᵥᵢₒᵤₛ)/log(Rₚᵣₑᵥᵢₒᵤₛ) (3)
(R_{current}−Rₚᵣₑᵥᵢₒᵤₛ)/sqrt(Rₚᵣₑᵥᵢₒᵤₛ) (4)

Any of these four methods may be implemented. The change calculation module 312 may select one of the methods as a default method and also allow a user to select a method appropriate to a particular situation. Although each technique is likely to end with a different result, each provides a measure of “newness”.

In embodiments of the invention, the BI engine 310 may cycle through all available dimensions to find the “hottest” dimension-members, such that users are not required to select a particular dimension or a particular group of dimensions for ranking.

The normalization module 316 may be implemented to normalize both the relevance score R and the newness score N within dimensions so that both scores are comparable (i.e. between zero and one). Normalization enables effective comparison between dimensions. For example, in the “Advertiser Country” dimension, chances are that the majority, i.e. 70% of advertisers will be from the United States. The relevance score for the United States in the Advertiser Country dimension is therefore 0.7.

In the “keyword” dimension however, relevance calculation module 314 may find the keyword with the highest relevance to be “yahoo” with a value of 0.02. In the keyword dimension, a score of 0.02 may be considered relatively substantial. To effectively compare between the country and keyword dimensions, the normalization module 316 normalizes each dimension to a similar scale (i.e. between 0 and 1). Without normalization, significant keyword findings might be lost since relevance for keywords will always be less than relevance for advertiser countries due to the number of the members in each dimension as well as the general distributions of the members.

The normalization module 316 may implement any of several normalization methods. In a first linear scaling method, the normalization module 316 may calculate each member's normalized value by the formula:
(Value_{member}−Valueₘᵢₙ)/(Valueₘₐₓ−Valueₘᵢₙ) (4)

A second normalization technique may be referred to as a ranking technique and may include sorting all members by descending value, then assigning each member with a value of:
(N−rank)/N (5)
where N is the number of members in a dimension and “rank” is the rank of the member. The members may be sorted in descending order by relevance or newness with the highest ranking member having a rank of 1.

In a third technique, the normalization module 316 may divide by the sum of values. In this instance, each member's normalized value is equal to:
Value_{member}/Σ(Valueᵢ) (6)
for all i members in the dimension.

As set forth above with respect to relevance calculations, any of the methods of formulas (4)-(6) may be implemented in the normalization module 316. Each or the formulas may yield a different result and an appropriate formula may be selected based on the total number of members in a dimension or some other factor. In embodiments of the invention, the system will select a default formula in the absence of a user selection.

The hot value calculation module 318 calculates a hot item score H for each member in a dimension. In order to calculate H, the hot value calculation module calculates
W_{R}R+W_{N}N (7)
where R is the relevance score, N is the newness score and W_{R} and W_{N} are weights associated with the relevance and newness scores. In embodiments of the invention, a default for each weight is set equal to 1. However, the user as an option can adjust these weights. For example, a user of the system might be more interested in what's new and less interested in what's relevant. Similarly, users might be interested in top percentages, i.e. the top advertisers contributing to revenue, regardless of whether or not their percentages have remained similar in the past few months.

The reverse hot value module 320 calculates “What's Not Hot” To calculate the “What's Not Hot” score, the hot value calculation module 318 may use the formula:
(1/W_{N})R+(1/W_{R})N (8)
where R is the relevance score, N is the newness score and W_{R} and W_{N} are weights associated with the relevance and newness scores. Again, in embodiments of the invention, default weights are set equal to one.

The weights W_{N} and W_{R} in equation (8) are inverted to facilitate calculation of what is “unhot”. If a user wants to put a heavier weight on relevance, then the smaller R is, the more “unhot” the item is. Similarly, if the user wants to put a heavier weight on newness, the smaller the N, the more “unhot” the item is. In the case of “What's Not Hot”, the BI engine 310 ranks the top “Unhot” items as those with the lowest scores.

Once the BI engine 310 calculates newness, relevancy, hot value, or reverse hot value, the BI visualizer 350 provides the users with a graphic display of the data. The BI visualizer 350 shows the hot facts in fact summaries. The fact summaries can be in many different forms. For example, in embodiments of the invention, the fact summary may show a top five or ten results, bottom five or ten results or a “what's hot” and “what's not” list. The BI visualizer 350 may include summary components 360 and exploratory components 370, each of which will be further described below with reference to FIG. 3B.

Summary components 360 may provide the users with a summary screen on which users of the system can view fact summaries for members of various dimensions, or combinations thereof, related to the measures and time frames selected. Each fact summary, dimension, or measure combination is summarized through a chart in a chart window.

As illustrated in FIG. 3B, users may select a fact summary using a fact summary selection module 364. Multiple charts can appear in the summary screen so that comparisons can be made for analysis purposes. Users can customize chart windows by selecting chart types, formats, etc. using a set of chart customization tools 362. Users can filter or drill down using very detailed or broad criteria, and users can move or resize windows.

In the summary screen of the BI visualizer 350, many results per page may be provided. In embodiments of the invention, different view windows are provided within each results page. In each view window, the user can select only one measure, but can look at multiple fact summaries for multiple dimensions or combinations of dimensions related to the measure selected for that view window. View windows on the same results page may be shown on the same summary screen.

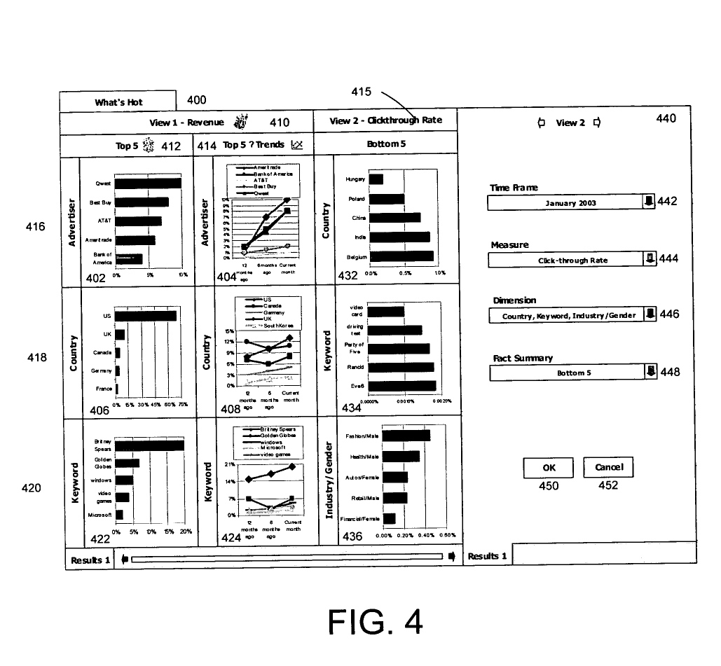

As illustrated in FIG. 3B, the exploratory components 370 may include a node tree structure generation mechanism 372, a chart adjustment mechanism 374, a node adjustment mechanism 376, an edge adjustment mechanism 378, and display options 380. Each of these components will be further described below with reference to the charts shown in FIGS. 4-8.

FIG. 4 illustrates a “What's Hot” summary screen 400 having two views 410 and 440. The first view 410 shows revenue as a measure and the second view 415 shows click-through rate as a measure.

In the first view 410 that is related to a revenue measure, the top five advertisers 416, the top five countries 418, and the top five keywords 420 are displayed. A column 412 shows bar graphs illustrating the top five of each dimension in terms of relevance R as explained above. Column 414 displays the top five in terms of newness N as explained above by showing a graph plotting time versus percent.

Bar graph 402 illustrates the advertisers Qwest, Best Buy, AT&T, Ameritrade, and Bank of America as having the highest advertiser revenues. Bar Graph 406 illustrates the countries including the US, the UK, Canada, Germany, and France having the highest percentage of revenues per country. Bar graph 422 illustrates the keywords Britney Spears, Golden Globes, windows, video game, and Microsoft as having the highest revenues per keyword.

Similarly, graph 404 illustrates the newness N for advertisers, with Ameritrade, Bank of America, AT&T, Best Buy, and Qwest having the highest percentage increases. Graph 408 illustrates revenue trends for countries including the US, Canada, Germany, the UK, and South Korea over time. Graph 424 shows trends in revenue in the keyword dimension for the keywords mentioned above with respect to graph 422.

In the second view 415, the bottom five click-through rates are shown in terms of relevance for the dimensions of country in chart 432, keyword in chart 434, and an industry/gender combination in chart 436.

The frame 440 in the second view 415 to the right of the charts 432-436 houses selection boxes in which users make choices to select and filter the data shown in the view windows 410 and 415. A time frame selection box 442 allows the user to select an applicable timeframe for measurement. A measure selection box 444 allows a user to select a measure for analysis such as click-through rate or revenue. A dimension selection box 446 allows a user to select a dimension, such as country or keyword. Finally, an “ok” selection box 450 allows the user to confirm the selections and a cancel selection box 452 allows a user to cancel the selections.

The exploratory components 370 of the BI visualizer 350 supplement the summary component 360 to provide a presentation based on a chart tree, where in embodiments of the invention, each node in the tree is represented as a chart. The tree is an exploratory tree provided by the node tree structure generation mechanism 372 such that the user can examine each node in the tree. When a user is interested in drilling down on a particular item of interest in a chart, the user selects the item in the summary screen, such as any of the representations shown in the summary screen of FIG. 4.

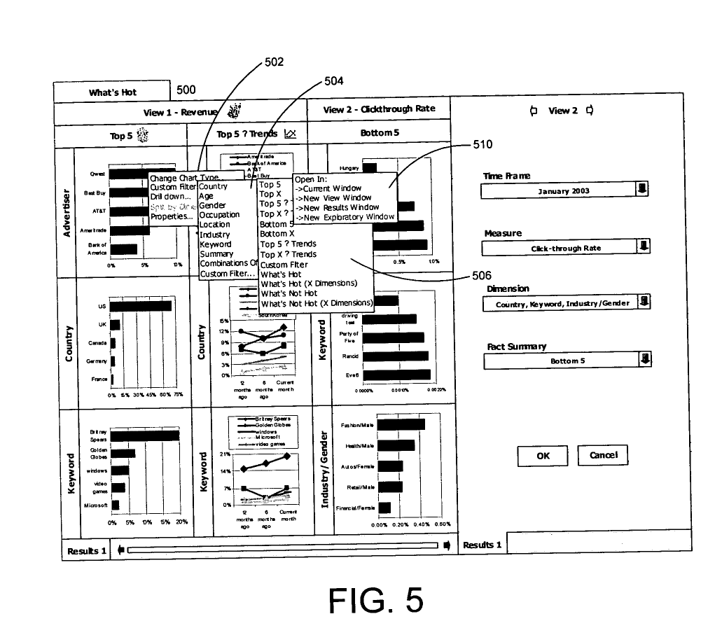

FIG. 5 illustrates the resultant display 500 when a user selects a displayed item. When the user selects the top five advertiser chart, a menu 502 appears. The menu 502 provides a list of options for the user. By selecting items on the menu 502, the user may change a type and format of each chart. Furthermore, the menu 520 enables a user to change and/or filter the data shown in a chart. The menu 502 further provides an option for the user to drill down on dimensions such that the current chart will be replaced, by a drilling component within the chart customization component 374, with the drilled down information in the form of a new chart. Furthermore, the menu 502 allows the user to see properties related to an item in the selected chart.

If the user selects the drill down option, a menu 504 will appear that lists the dimensions the user can drill down on with respect to the item clicked on the chart. After selecting the dimension, the menu 504 expands to create the menu 506 to allow the user to select the fact summary type to view such as “top five” or “what's hot” or other summary type. Finally the menu 510 is provided that allows the user to drill down on the item of interest in the current window, in a new view window, in a new results window or in a new exploratory window. If the user elects to expand the item in the current window, the currently displayed chart will be replaced by the new drilled down chart. If the user selects the new view window, the drilled down information will appear as a chart in a new view window. If the user selects the new results window from the menu 510, the drilled down information will appear as a new view in a new results window. Finally, if the user selects the new exploratory window from the menu 510, the drilled down information will appear in a separate pop-up exploratory window.

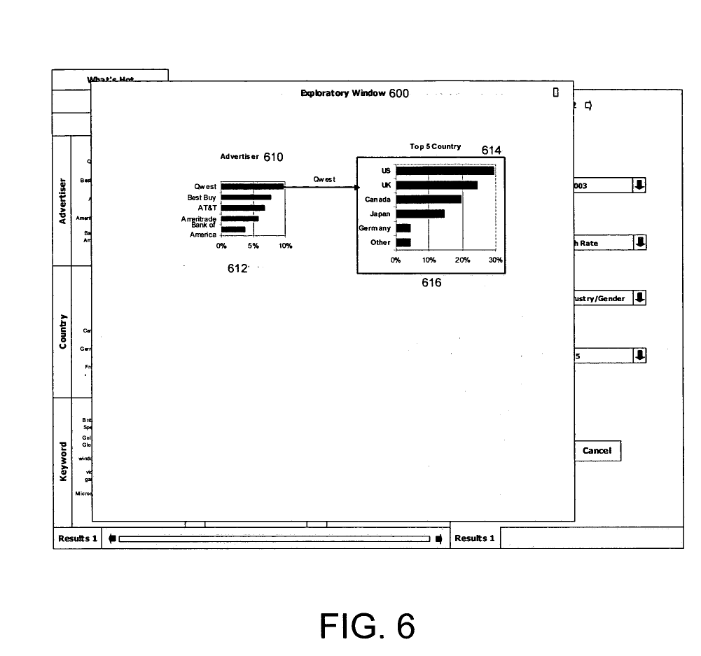

With further reference to FIG. 5, in the screen 500, the chart 520 shows Qwest as the advertiser with the most revenue. The user selected to drill down to see the top five countries in which Qwest generates revenue using a new exploratory window. This drilling down process brings up a new exploratory window 600 shown in FIG. 6.

As illustrated in FIG. 6, each chart node 610 and 614 contains a chart. Chart nodes 610 and 614 are linked to each other through an edge 612, where the name of the edge refers to the item that has been drilled down on. In FIG. 6, the name of the edge 612 is Qwest. The user drilled down on Qwest in the chart 610 to get to the top five country node. The top of each node shows the fact summary type and dimension that was drilled down on. The current in-focus node, illustrated as the country node 614, may appear larger and shaded compared to other nodes, such as the node 610.

In embodiments of the invention, in the visualizer 350, the “parent” and “child” chart nodes of the current in-focus chart node should be smaller, for example, approximately 2/3 the size of the current in-focus node. In such embodiments, all other chart nodes should be between one quarter to one third the size of the current in-focus node. Controls may be offered through the node adjustment mechanism 376 to allow the user to change the size ratios of parent nodes, child nodes, the current node and other nodes or manually change each node's size. The user should also be able to export any chart as a separate view or results page in summary mode, for example by right-clicking or other selection technique.

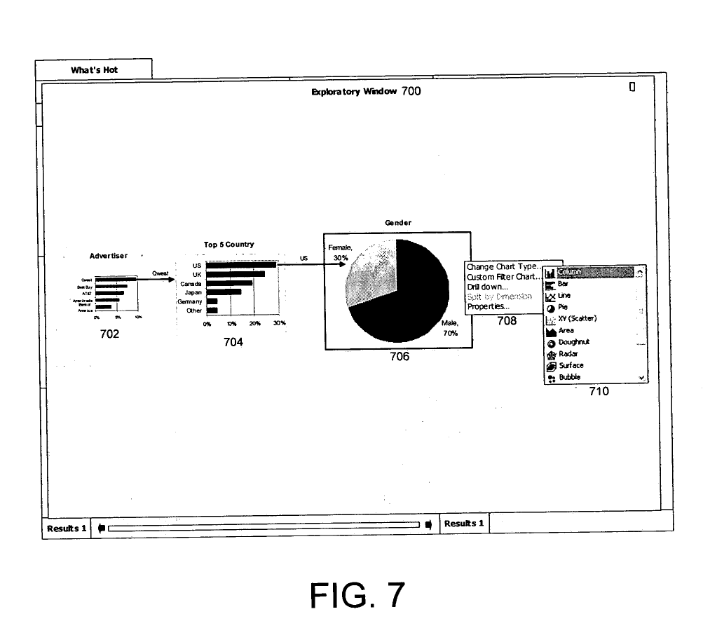

In FIG. 7, the user has drilled down on “US” from the chart 704 in the “Gender” dimension as shown by the current chart node 706. The current chart node 706 shows that 70% of revenue coming from the US on Qwest keyword advertisements is generated by males, while 30% of the revenue is generated by females. The chart node 706 illustrates a pie chart to show the distribution between females and males. As illustrated by menus 708 and 710, the user can explore different chart types available to the data in the node. As illustrated, the menu 710 provides options for column charts, bar charts, line charts, pay charts, scatter charts, area charts, doughnut charges, radar charts, surface charts, and bubble charts. Other options may also be provided.

The BI visualizer 350 should provide a plurality of UI options for changing node appearances. The node adjustment mechanism 376 may provide node options including the ability to turn on and off the borders of each node, the ability to turn on and off a node header, and the ability to collapse a node. Furthermore, the node adjustment mechanism 376 allows for adjustment of node sizes for the different classes of nodes including parent nodes, current nodes, child nodes, other nodes, all nodes, etc. The node adjustment mechanism 376 may additionally include a mechanism for adjusting font sizes and changing font colors within a node and may also provide a mechanism for deleting nodes and related edges.

In addition to the node options, the BI visualizer 350 may include a chart adjustment mechanism 374 that provides a plurality of chart options for changing chart appearances. For example, the chart adjustment mechanism 374 may provide for changing a chart type, filtering a chart, and drilling down further on a chart. In embodiments of the invention, the options for drilling down further may allow drilling down by different measures, dimensions, and fact summary types. Further chart options may include a property viewing option and a color revision option. Color within a chart may be selected based on the displayed measure, each measure receiving a different color. Chart colors may also be adjusted to reflect (1) different dimensions, (2) different hotness factors, or (3) areas containing values for certain measures.

The BI visualizer 350 may also provide an edge adjustment mechanism 378 in accordance with embodiments of the invention. Edge adjustment may include the ability to turn an edge name on or off and to have an edge weight represent values associated with the selected item in relation to parent node, root node or absolute value. The edge adjustment mechanism 378 may additionally provide the user with the capability to collapse one node and have the edge represent a combination of selected items. Finally, the edge adjustment mechanism should provide the capability for adjusting adjust average edge length and average edge weight.

The BI visualizer 350 may additionally include multiple selectable display options 380. In embodiments of the invention, the display options may provide the capability to reorganize nodes in the display automatically. The display options may additionally provide a selectable option for allowing the screen to automatically refresh to centralize a node. Horizontal and/or vertical scrollbars may also be positioned within the display. Furthermore, the display options 380 should include a zooming mode, so that as a user moves around the chart node tree, each node is enlarged when a user input device passes over the node and returns to its original size after the user input device leaves the node. The display options may additionally include individual enlargement of nodes such as for example, by right-clicking and selecting an “enlarge node” option.

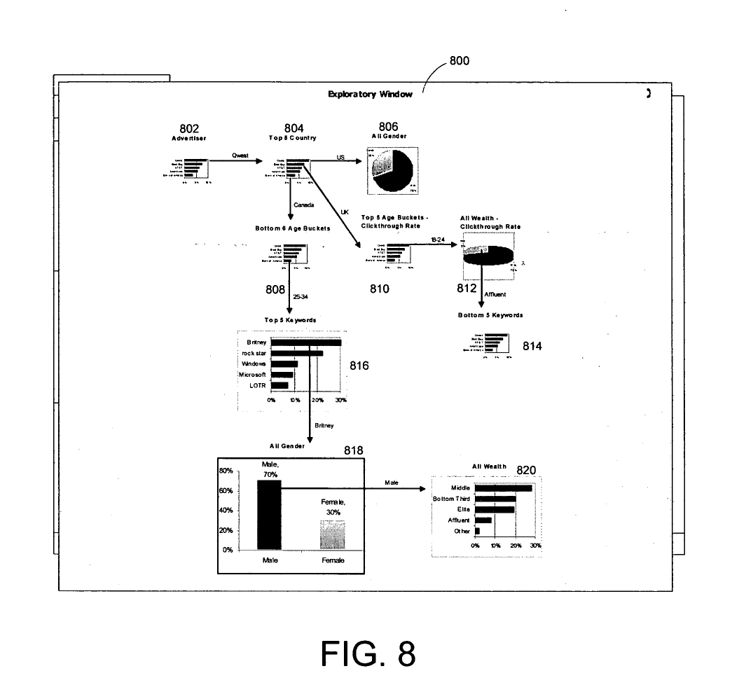

FIG. 8 illustrates a chart node tree 800 that a user may create using the BI visualizer 350. The chart node tree 800 includes nodes 802, 804, and 806 connected on a first level. The first level of nodes is connected with a second level including nodes 808, 810, and 812. A third level includes nodes 814 and 816 and a final level includes nodes 818, and 820. Each of the aforementioned nodes is connected with at least one other node via an edge. As set forth above, the BI system 300 is capable evaluating performance of a business or a portion of the business and of determining what is new and what is hot. The system is relevant to users who may include anyone from top level executives to interested data analysts. The BI engine 310 and visualizer 350 can be used with OLAP data in any application where these types of questions are relevant. The exploratory mode 360 of the visualizer 350 also uses the concept of a chart node tree for exploration. The BI system 300 provides a wealth of business intelligence analysis and exploratory power.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A business intelligence visualization system for presenting business intelligence data to a user, the visualization system comprising:
a node tree structure generation mechanism for generating a node as a portion of a tree for displaying data; and
a drilling component for allowing user selection of at least one additional node for generation by the node tree structure generation mechanism.

2. The system of claim 1, further comprising summary components for providing a fact summary within a user display.

3. The system of claim 2, wherein each node is represented by a chart and the summary components provide for user selection of chart type.

4. The system of claim 2, wherein the summary component provides multiple view windows, wherein each view window represents a single selected measure.

5. The system of claim 1, wherein the drilling component creates an edge between a previously existing node and a new node.

6. The system of claim 5, further comprising a user controlled edge adjustment mechanism for allowing the user to alter an edge appearance.

7. The system of claim 1, further comprising a user controlled node adjustment mechanism for allowing the user to alter node appearance.

8. The system of claim 7, wherein the node adjustment mechanism allows the user to change a node size.

9. A business intelligence system for deriving and displaying business intelligence data, the system comprising:
a business intelligence engine for analyzing information from a database, the business intelligence engine comprising,
a change calculation mechanism for calculating a measure of change between a member value or function of a member value during a previous time period and a member value or function of a member value in a current time period,
a relevance calculation mechanism for calculating a member value percentage within a category, and
a hot value calculation module for calculating whether a member has a hot status based upon the relevance calculation and the change calculation for that member; and
a business intelligence visualizer for creating a graphic display for conveying at least one of change, relevance, and hot item status.

10. The system of claim 9, further comprising a normalization module for normalizing the change calculation and the relevance calculation.

11. The system of claim 10, wherein the hot value calculation module applies a first weight to a change calculation and a second weight to the relevance calculation and sums the calculations with applied weights to find a hot item score.

12. The system of claim 9, further comprising a reverse hot value calculation module for determining least hot items.

13. The system of claim 12, wherein the reverse hot value calculation module applies a first inverse weight to the change calculation and a second inverse weight to the relevance calculation and sums the weighted calculations to reach a least hot item score.

14. The system of claim 9, wherein the visualizer comprises summary components and exploratory components.

15. The system of claim 14, wherein the summary components provide multiple view windows, each view window representing a user-selected measure.

16. The system of claim 14, wherein the exploratory components comprise a node tree structure generation mechanism for generating a node as a portion of a tree for displaying data.

17. The system of claim 16, further comprising a drilling component for allowing user selection of at least one additional node for generation by the node tree structure generation mechanism.

18. The system of claim 17, wherein the drilling component creates an edge between a previously existing node and a new node.

19. The system of claim 18, further comprising a user controlled edge adjustment mechanism for allowing the user to alter an edge appearance.

20. The system of claim 17, further comprising a user controlled node adjustment mechanism for allowing the user to alter node appearance.

21. A method for deriving and presenting business intelligence data with information extracted from a database, the method comprising:
determining a measure of change between a member value during a previous time period and a member value in a current time period;
assessing relevance by calculating a member value percentage within a category;
and
ranking hot items for display based on a combination of relevance and change.

22. The method of claim 21, further comprising creating a graphic display for conveying at least one of change, relevance, and hot item status.

23. The method of claim 21, further comprising implementing a normalization module for normalizing the change calculation and the relevance calculation.

24. The method of claim 21, further comprising applying a first weight to the change calculation and a second weight to the relevance calculation and summing the calculations with applied weights to find a hot item score.

25. The method of claim 21, further comprising providing a reverse hot value calculation module for determining least hot items.

26. The method of claim 25, further comprising implementing the reverse hot value calculation module to apply a first inverse weight to the change calculation and a second inverse weight to the relevance calculation and summing the weighted calculations to reach a least hot item score.

27. A computer readable medium storing computer executable instructions for performing the method of claim 21.

28. The method of claim 22, further comprising providing a visualizer for creating a graphic display, the visualizer including summary components and exploratory components.

29. The method of claim 28, further comprising implementing the summary components to provide multiple view windows, each view window representing a user-selected measure.

30. The method of claim 29, further comprising providing a node tree structure generation mechanism as an exploratory component for generating a node as a portion of a tree for displaying data.

31. The method of claim 30, further comprising providing a drilling component for allowing user selection of at least one additional node for generation by the node tree structure generation mechanism.

32. The method of claim 31, further comprising creating an edge between a previously existing node and a new node.

33. The method of claim 31, further comprising providing a user controlled edge adjustment mechanism for allowing the user to alter an edge appearance.

34. The method of claim 31, further comprising providing a user controlled node adjustment mechanism for allowing the user to alter node appearance.

35. A method for organizing and displaying business intelligence data, the method comprising:
implementing a node tree structure generation mechanism for generating a node as a portion of a tree for displaying data; and
providing a drilling component for allowing user selection of at least one additional node for generation by the node tree structure generation mechanism.

36. The method of claim 35, further comprising providing summary components for providing a fact summary within a user display.

37. The method of claim 36, further comprising representing each node by a chart and the providing for user for user selection of chart type.

38. The method of claim 36, further comprising providing multiple view windows, each view window representing a single selected measure.

39. The method of claim 35, further comprising creating an edge between a previously existing node and a new node.

40. The method of claim 39, further comprising a providing user controlled edge adjustment mechanism for allowing the user to alter an edge appearance.

41. The method of claim 35, further comprising providing a user controlled node adjustment mechanism for allowing the user to alter node appearance.

42. The method of claim 41, further comprising providing the node adjustment mechanism with user selectable node sizes.

43. A computer readable medium storing computer executable instructions for performing the method of claim 35.
